(19) United States
(12) Patent Application Publication
(10) Pub. No.: US 2019/0065282 A1
(43) Pub. Date: Feb. 28, 2019

(54) INFORMATION PROCESSING APPARATUS AND INFORMATION PROCESSING SYSTEM

(71) Applicant: FUJITSU LIMITED, Kawasaki-shi (JP)

(72) Inventors: Miyuki Matsuo, Yokohama (JP); Kohta Nakashima, Kawasaki (JP)

(73) Assignee: FUJITSU LIMITED, Kawasaki-shi (JP)

(21) Appl. No.: 16/111,624

(22) Filed: Aug. 24, 2018

(30) Foreign Application Priority Data
Aug. 31, 2017 (JP) 2017-167096

(51) Int. Cl. G06F 9/50; G06F 1/20; G06F 9/38

(52) U.S. Cl. CPC G06F 9/5094; G06F 9/3877; G06F 1/206

(57) ABSTRACT

An information processing apparatus includes a processor that acquires a temperature of each of a plurality of arithmetic processing devices. The processor acquires a first raised temperature and a second raised temperature for a first predetermined processing. The first raised temperature is a temperature expected to be raised in a first arithmetic processing device if the first arithmetic processing device executes the first predetermined processing. The second raised temperature is a temperature expected to be raised in a second arithmetic processing device if the first arithmetic processing device executes the first predetermined processing. The second arithmetic processing device is different from the first arithmetic processing device. The processor determines an arithmetic processing device to be assigned to execute the first predetermined processing, based on the temperature of each of the plurality of arithmetic processing devices, the first raised temperature, and the second raised temperature.

### CROSS-REFERENCE TO RELATED APPLICATION

This application is based upon and claims the benefit of priority of the prior Japanese Patent Application No. 2017-167096, filed on Aug. 31, 2017, the entire contents of which are incorporated herein by reference.

### FIELD

The embodiments discussed herein are an information processing apparatus and an information processing system.

### BACKGROUND

In recent years, with the advent of an advanced information-oriented society, a large amount of data has been handled, and a large-scale computing environment having many computers is increasingly used for calculation. For example, in a large-scale computing environment, one or more jobs are put into each computer, and a complex arithmetic processing is implemented by integrating the jobs executed by the respective computers.

Here, the job is a processing unit that performs one integrated job in a program. In addition, here, a physical lump to which a job may be put, that is, one device which is a unit of putting a job is called a node. For example, in the case of a computer that has multiple physical components such as a central processing unit (CPU) or a CPU socket, when a job is put for each physical component, the physical component is one node. A server device in which multiple nodes are mounted on a single housing as a computer is called a multi-node server. For example, the multi-node server includes a device in which four nodes on the front surface of the housing and four nodes on the rear surface thereof may be placed.

In such a large-scale computing environment, a large number of computers are installed in the same room and are managed collectively. Under such circumstances, there is a possibility that a large amount of heat is generated from the computer and the processing performance is degraded.

For this reason, each computer has an upper limit of the temperature for proper operation. Generally, as the operating frequency of a node becomes higher, the computer may exhibit a higher performance. Also, the temperature of the computer increases by executing the program. As the temperature rises, the computer avoids the rise in temperature by suppressing the increase in the operating frequency of the node so as not to exceed the upper limit of the temperature. However, when the operating frequency of the node is kept low, the processing performance of the computer is degraded. Therefore, the computer may be caused to execute the program so that the node operates in a range that is not subjected to temperature restrictions.

In this way, two types of cooling methods, air-cooling and water-cooling, may be considered as cooling methods for suppressing the temperature of an arithmetic device.

In addition, there has been proposed a technique to operate a computer with temperature restrictions in the related art in which the thermal characteristics of each physical component at the time of computation are measured in advance, and a task is assigned to each physical component so as not to exceed a thermal threshold value based on the measured thermal characteristics. Also, there has been proposed a technique in the related art in which the load factor and temperature characteristic information predicted according to a task assignment is stored in advance and a task is assigned by selecting a placement pattern having a small maximum temperature from the placement patterns indicating the assignment methods of the plurality of tasks. Further, there has been proposed another technique in the related art in which the permissible processing amount within the limit temperature of each node computer is calculated based on the ambient temperature, the internal temperature, and the load of the CPU to distribute the work within the permissible processing amount to each node computer.

Related technologies are disclosed in, for example, Japanese Laid-Open Patent Publication No. 2005-285123, Japanese Laid-Open Patent Publication No. 2009-277022, and Japanese Laid-Open Patent Publication No. 2005-141669.

### SUMMARY

According to an aspect of the present invention, provided is an information processing apparatus including a memory and a processor coupled to the memory. The processor is configured to acquire a temperature of each of a plurality of arithmetic processing devices. The processor is configured to acquire a first raised temperature and a second raised temperature for a first predetermined processing. The first raised temperature is a temperature expected to be raised in a first arithmetic processing device if the first arithmetic processing device executes the first predetermined processing. The second raised temperature is a temperature expected to be raised in a second arithmetic processing device if the first arithmetic processing device executes the first predetermined processing. The second arithmetic processing device is different from the first arithmetic processing device. The processor is configured to determine an arithmetic processing device to be assigned to execute the first predetermined processing, based on the temperature of each of the plurality of arithmetic processing devices, the first raised temperature, and the second raised temperature.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic configuration diagram of an information processing system;

FIG. 2 is a block diagram of a management node;

FIG. 3 is a diagram illustrating an example of a node information table according to a first embodiment;

FIG. 4 is a diagram illustrating an example of a job information table according to the first embodiment;

FIG. 5 is a diagram illustrating a node information table in a state in which job X is assigned;

FIG. 6 is a diagram illustrating a node information table in which job Y is assigned;

FIG. 7 is a diagram illustrating a node information table in a state in which job Z is assigned;

FIG. 8 is a flowchart of a job assignment processing by a management node according to the first embodiment;

FIG. 9 is a diagram illustrating an example of a node information table according to a second embodiment;

FIG. 10 is a diagram illustrating an example of a job information table according to the second embodiment;

FIG. 11 is a diagram illustrating an example of a job information table according to a third embodiment; and

FIG. 12 is a hardware configuration diagram of a management node.

### DESCRIPTION OF EMBODIMENTS

In any of the cooling methods such as the air-cooling method and the water-cooling method, since a cooling medium is caused to flow to cool each node, the temperature of the upstream side of the cooling medium flow becomes lower than that of the downstream side. For example, in the water-cooling method, when the upstream side node becomes hot, since the water is deprived of much heat by cooling the upstream side node, it becomes difficult to cool the downstream side node and the downstream side node becomes hot. Here, when there are multiple flow paths in the cooling medium in the water-cooling, even when the temperature of the downstream side node rises due to the heat of the upstream side node in one flow path, the temperature of the downstream side node of the other flow path does not rise as much. Also, even when the downstream side node becomes hot, this does not influence the upstream side node and the temperature thereof does not rise. In the case of the air-cooling, for example, it is considered that air is caused to flow from the front surface to the rear surface. Even in this case, however, the downstream side node of the air flow is influenced by the heat of the upstream side node and the temperature thereof rises. Thus, a temperature dependency occurs according to the mounting position of the node with respect to the flow path of the cooling medium. Therefore, even when the operation of each node is controlled without considering the mounting position of the node relative to the flow path of the cooling medium, the temperature of the node may exceed a temperature threshold value, and it is difficult to suppress the degradation of the processing performance of the computer.

In this regard, in the related art in which tasks are assigned so as not to exceed a thermal threshold value based on measured thermal characteristics, it is difficult to suppress the processing performance deterioration of the computer without considering the mounting position of the node with respect to the flow path of the cooling medium. This is the same in both the related art in which a placement pattern with a low maximum temperature is selected among the placement patterns of tasks and the related art in which a job within the permissible processing amount is distributed to each node computer.

The technology described herein has been disclosed in view of the foregoing and provides an information processing apparatus configured to suppress the processing performance degradation of a computer, an information processing program, a control method of the information processing apparatus, and a control program of the information processing apparatus.

Hereinafter, embodiments of an information processing apparatus and an information processing system in the present disclosure will be described in detail with reference to the accompanying drawings. Further, the following embodiments do not limit the information processing apparatus, the information processing system, the control method of the information processing apparatus, and the control programs of the information processing apparatus described in the present disclosure.

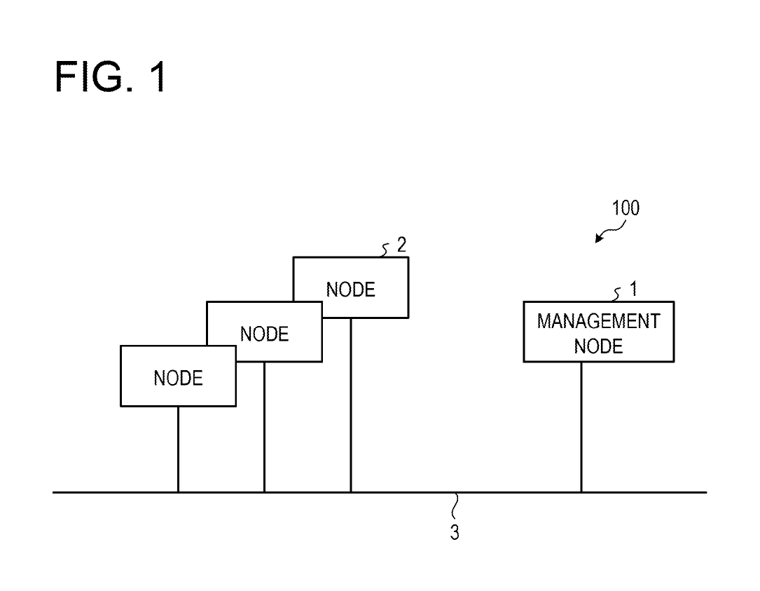

FIG. 1 is a schematic configuration diagram of an information processing system. As illustrated in FIG. 1, the information processing system 100 according to the present embodiment includes a management node 1 and multiple nodes 2. The management node 1 and the nodes 2 are connected by a network 3. The network 3 is, for example, Infiniband (registered trademark).

Each node 2 is a unit of putting a job. For example, in a case where multiple CPUs are mounted on a single computer, when the job may be put to the respective CPUs, each CPU becomes a node 2. In addition, when one job is put to one computer, each computer becomes a node 2.

The node 2 executes the job put into the node. A single job may be executed by the plurality of nodes 2 or may be executed by a single node 2. In addition, each node 2 may execute a different job. The node 2 is an example of an “arithmetic processing device.”

The management node 1 executes a job scheduler that determines the job assignment to the node 2 and puts the job to the assigned node 2. Specifically, the management node 1 receives an input of a job to be executed by an operator on the node 2. Then, the management node 1 assigns the job by selecting the node 2 that executes the job input by the operator. Then, the management node 1 executes the job by putting the job to the node 2 to which the job is assigned. The management node 1 is an example of the “information processing apparatus.”

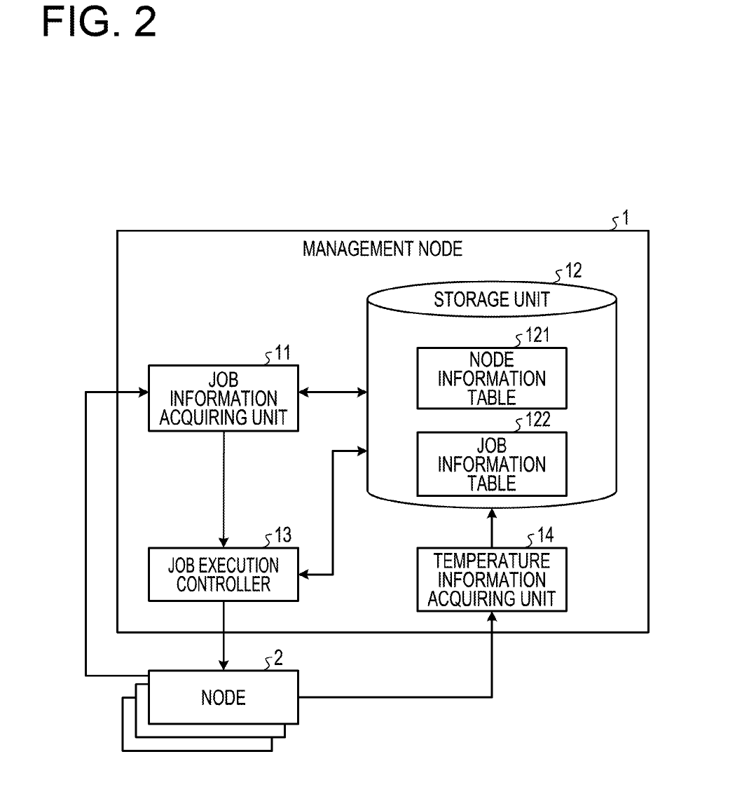

Next, the job assignment to the node 2 by the management node 1 will be described with reference to FIG. 2. FIG. 2 is a block diagram of the management node 1. The management node 1 includes a job information acquiring unit 11, a storage unit 12, a job execution controller 13, and a temperature information acquiring unit 14.

The storage unit 12 is a storage device such as a hard disk. The storage unit 12 includes a node information table 121 and a job information table 122 which are input from an operator in advance.

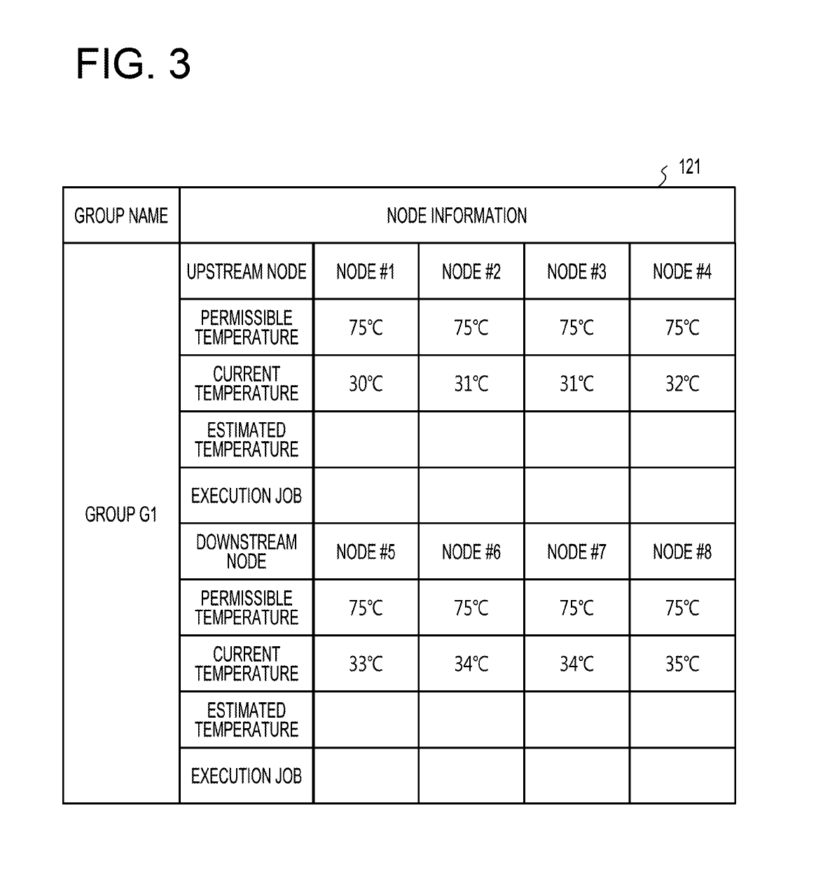

FIG. 3 is a diagram illustrating an example of the node information table according to a first embodiment. As illustrated in FIG. 3, the node information table 121 includes a register column for a permissible temperature, a current temperature, an estimated temperature, and an execution job for each node 2. Here, descriptions will be made of a case where four nodes 2 are arranged on the front surface of one computer and four nodes 2 are arranged on the rear surface corresponding to each node 2 which is disposed on the front surface. That is, when the computer is viewed from the front side, the nodes 2 on the front surface and the corresponding nodes 2 on the rear surface are in a superimposed state. Also, the cooling medium flows from the front surface to the rear surface of the computer. In the following description, the node 2 disposed on the front surface of the computer, that is, the node 2 disposed at a position corresponding to the upstream of the flow path of the cooling medium is referred to as an upstream node. Also, the node 2 disposed on the rear side of the computer, that is, the node 2 located at a position corresponding to the downstream of the flow path of the cooling medium is referred to as a downstream node. In addition, eight nodes 2 disposed in the computer are referred to as nodes #1 to #8, respectively.

In the node information table 121, the nodes 2 stored in one housing become one group. In addition, the temperature rise of the upstream node influences the downstream node corresponding to the upstream node. Therefore, in the node information table 121, the upstream node on the influencing side and the downstream node on the influenced side are registered as separate integrations, respectively.

In addition, in the node information table 121, the influencing upstream node and the influenced downstream side are registered up and down such that these nodes correspond to each other. A set of the upstream node which is an influencing side and the downstream node which is an influenced side in the node information table 121 is called a temperature influence range. Here, in the present embodiment, a set of the upstream node and the downstream node arranged next to each other is defined as the temperature influence range, but the temperature influence range is not limited thereto. For example, when the downstream node arranged next to the upstream node and another downstream node adjacent thereto are also influenced by the temperature rise of the upstream node, those downstream nodes are in the temperature influence range. The temperature influence range and the designation of an influencing side node 2 and an influenced side node 2 in the influence range are the information input from the operator.

FIG. 3 illustrates the temperature influence range by arranging the nodes 2 in one line, but the temperature influence range may be indicated by another method as long as the temperature dependency may be expressed by dividing the influencing side and the influenced side. For example, when the temperature influence range overlaps, a node in which the influence range overlaps may be indicated by one point and a link to the information may be set at multiple points. In the present embodiment, the upstream node in the temperature influence range is the influencing side node 2, and the downstream node is the influenced side node 2. The influenced side node 2 such as the downstream node corresponds to an example of an “influenced arithmetic processing device.” Further, information on the temperature influence range, and the influencing side node 2 and the influenced side node 2 in the influence range corresponds to an example of information on “an influenced arithmetic processing unit in which the temperature rises when the temperature of a predetermined arithmetic processing device rises.”

The permissible temperature in the node information table 121 is an upper limit of the temperature of each node 2. The permissible temperature is registered in advance according to the specification of each node 2. Further, the current temperature is the current measurement temperature of each node 2. In addition, the estimated temperature is the temperature reached when each node 2 executes the job. Also, the execution job is a job assigned to each node 2.

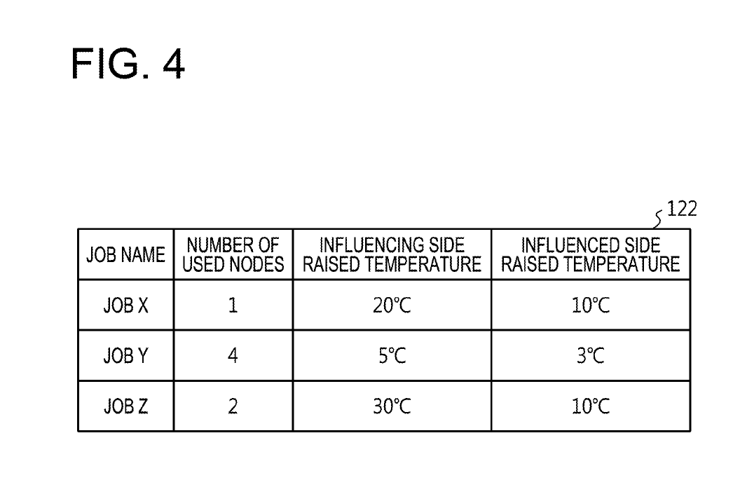

Further, FIG. 4 is a diagram illustrating an example of a job information table according to the first embodiment. The job information table 122 registers the number of used nodes of each job, the influencing side raised temperature, and the influenced side raised temperature. The influencing side raised temperature represents a temperature raised in a node 2 when the node 2 executes a job. Also, the influenced side raised temperature represents a temperature raised in an influenced side node 2 when an influencing side node 2, which is arranged within the temperature influence range, executes a job. For example, when node #1 executes node X, the temperature of the node #1 rises by 20° C. and the temperature of node #5 rises by 10° C. For example, the influencing side raised temperature and the influenced side raised temperature when the job is executed in advance are registered in the job information table 122. In addition, the job information table 122 may register the influencing side raised temperature and the influenced side raised temperature included in the execution history of each job executed in the past. The influencing side raised temperature and the influenced side raised temperature in the job information table 122 correspond to examples of a “first raised temperature” and a “second raised temperature.”

Here, in the present embodiment, one type of temperature is set as the influenced side raised temperature since the upstream node and the downstream nodes arranged next to each other are included in the temperature influence range. However, when there are multiple influenced side nodes 2 and the influenced side nodes 2 are each influenced differently, different types of the influenced side raised temperature may be set depending on the influence.

The job information acquiring unit 11 executes each job on the node 2 in advance and acquires the influencing side raised temperature and the influenced side raised temperature in that case. Then, the job information acquiring unit 11 registers the influencing side raised temperature and the influenced side raised temperature in the job information table 122 of the storage unit 12 when each of acquired jobs is executed. In addition, the job information acquiring unit 11 may acquire the influencing side raised temperature and the influenced side raised temperature from the execution history of the job executed in the past, and register the acquired information in the job information table 122.

The job information acquiring unit 11 receives a job. Here, the job information acquiring unit 11 may receive a job by receiving a job execution instruction from the operator, or may receive a job by reading the information of a pre-registered job at a determined timing. Next, the job information acquiring unit 11 acquires the job name of the received job. Then, the job information acquiring unit 11 acquires the number of used nodes corresponding to the acquired job name, the influencing side raised temperature, and the influenced side raised temperature from the job information table 122. Then, the job information acquiring unit 11 outputs the job name, the number of used nodes, the influencing side raised temperature, and the influenced side raised temperature to the job execution controller 13. This job information acquiring unit 11 is an example of a “raised temperature acquiring unit.”

The temperature information acquiring unit 14 periodically collects the current measurement temperature from each node 2. For example, the temperature information acquiring unit 14 may acquire temperature information from a model specific register (MSR) that holds CPU information. In addition, the temperature information acquiring unit 14 may acquire temperature information from the intelligent platform management interface (IPMI), which is an interface that acquires various sensor information of hardware and performs a remote operation. The temperature information acquiring unit 14 then registers the current measurement temperature of each node 2 in the current temperature column of each node 2 of the node information table 121.

The job execution controller 13 receives an input of the job name of the job to be executed, the number of used nodes, and the influencing side raised temperature, and the influenced side raised temperature from the job information acquiring unit 11. In the following description, the job having the input job name is called the received job.

The job execution controller 13 selects the nodes 2 that are not executing a job among the nodes 2 registered in the node information table 121 and adds the value of the influencing side raised temperature to the current temperature so as to calculate the temperature of each node 2 when the received job is executed. Then, the job execution controller 13 extracts the nodes 2 that do not exceed the permissible temperature when the received job is executed from the nodes 2 that are not executing the job. Hereinafter, the extracted nodes 2 are referred to as “usable nodes.”

Next, the job execution controller 13 selects the node 2 having the number of used nodes in the received job among the usable nodes. For example, the job execution controller 13 selects the node 2 in the descending order of the current temperature. However, this selection of the node 2 may be performed in another method, for example, by integrating an influencing side node 2 and an influenced side node 2, or in the ascending order of the number pre-assigned to the node 2. Hereinafter, the node 2 selected by the job execution controller 13 is referred to as an “assignment candidate node.”

Next, the job execution controller 13 determines whether there is an influencing side node 2 among the assignment candidate nodes and whether there is an influenced side node 2 included in the temperature influence range of the influencing side node 2. When it is determined that there are the influencing side node 2 and the influenced side node 2 in the same temperature influence range in the assignment candidate nodes, the value of the influenced side raised temperature is added to the temperature of the influenced side node 2 after the rise. Here, when one node 2 in the assignment candidate nodes is the influenced side node 2 for the plurality of influencing side nodes 2 in the assignment candidate nodes, the influenced side raised temperature is added to the temperature of the influenced side node 2 according to the influencing side node 2 included in the assignment candidate nodes. Then, the job execution controller 13 determines whether there is a node 2 exceeding the permissible temperature among the influenced nodes 2 included in the assignment candidate nodes. When it is determined that there is a node 2 exceeding the permissible temperature, the job execution controller 13 selects an assignment candidate node of another combination from the usable nodes and repeats the processing until now.

When it is determined that there is no node 2 exceeding the permissible temperature, the job execution controller 13 determines whether there is the influencing side node 2 in the assignment candidate nodes. When it is determined that there is the influencing side node 2, the job execution controller 13 specifies the node 2 that falls within the temperature influence range of the node 2 and is not included in the assignment candidate nodes. Then, the job execution controller 13 adds the value of the influenced side raised temperature to the current temperature of the specified node 2. Then, the job execution controller 13 determines whether the addition result exceeds the permissible temperature. When it is determined that the addition result exceeds the permissible temperature, the job execution controller 13 selects the assignment candidate node of another combination from the usable nodes and repeats the processing until now.

In the meantime, when it is determined that the addition result does not exceed the permissible temperature, the job execution controller 13 determines to assign the received job to the assignment candidate node. Then, the job execution controller 13 registers the value obtained by adding the influencing side raised temperature when the received job is executed to the current temperature of the node 2 to which the received job is assigned in the node information table 121 as the estimated temperature. In addition, when there is the influencing side node 2 in the nodes 2 which assign the received job, the job execution controller 13 calculates and registers the estimated temperature of the influenced side node 2 in the temperature influence range of the node 2. Specifically, when the estimated temperature is already registered in the influenced side node 2, the job execution controller 13 registers the value obtained by adding the influenced side raised temperature by the execution of the received job by the influencing side node 2 to the already-registered estimated temperature of the influenced side node 2 as the newly estimated temperature. When the exposed estimated temperature is not registered on the influenced side node 2, the job execution controller 13 registers the value obtained by adding the influenced side raised temperature by the execution of the received job by the influencing side node 2 to the current temperature of the influenced side node 2 as the estimated temperature.

Here, since the temperature of one of the nodes 2 exceeds the permissible temperature, when the assignment of the received job is difficult, the job execution controller 13 waits until the temperature of each node 2 decreases and the assignment of the received job may be performed. Thereafter, the job execution controller 13 again performs the extraction of the usable nodes, the selection of the candidate node determination, and the determination of whether the assignment of the received job is performed as described above. This job execution controller 13 is an example of an “execution controller.” Also, the received job is an example of a “predetermined processing.”

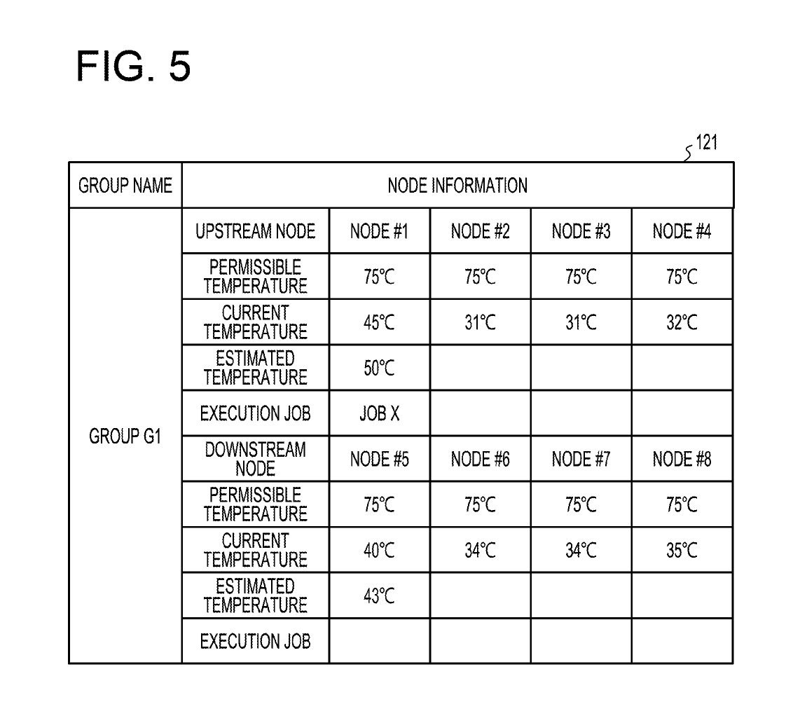

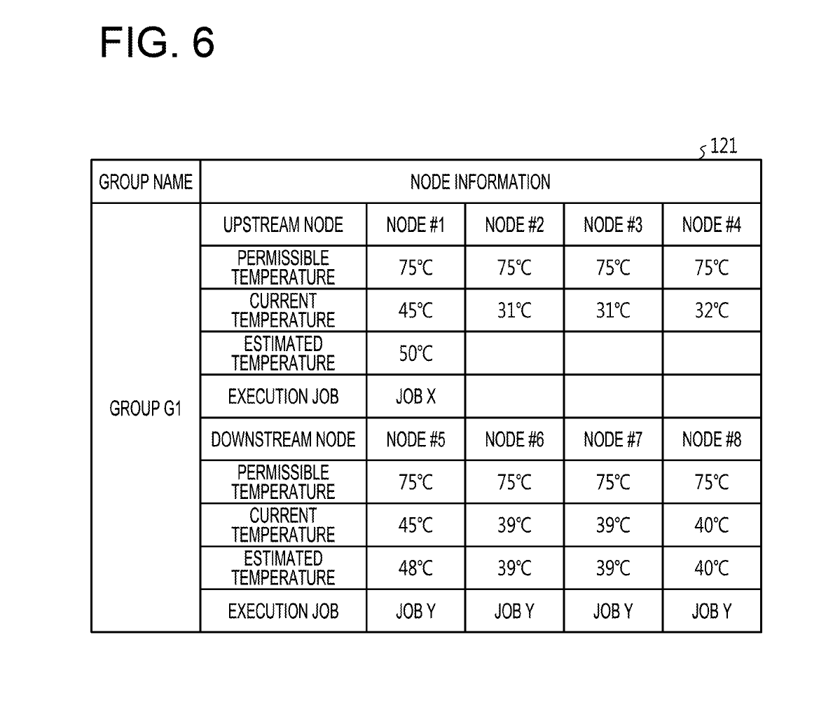

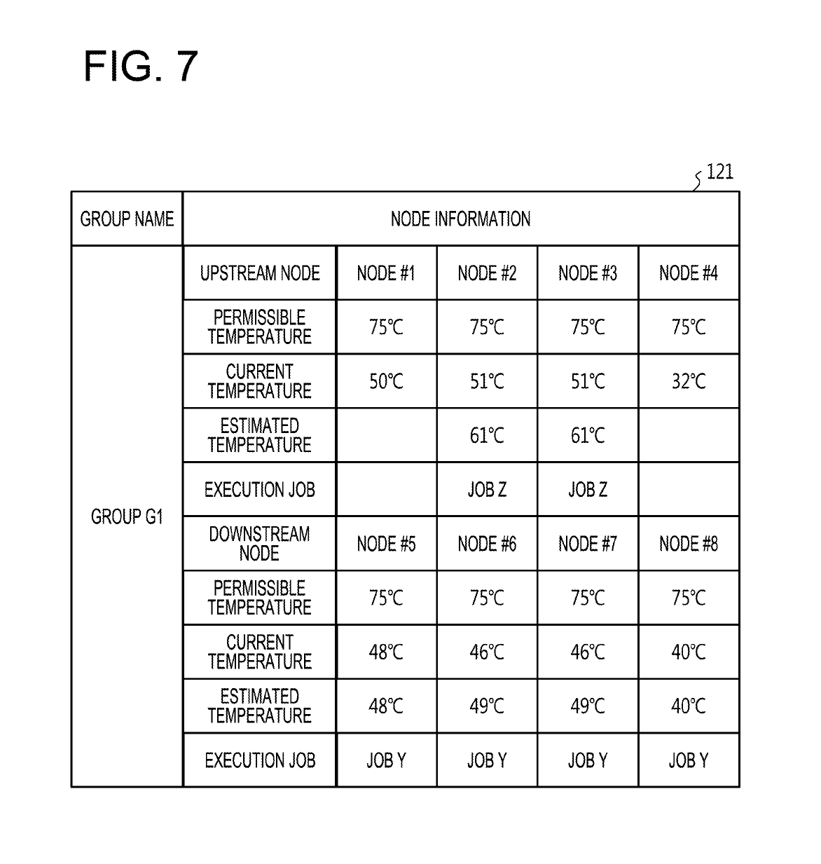

Here, an example of the job assignment by the job execution controller 13 will be described with reference to FIGS. 3, 4, and 5 to 7. FIG. 5 is a diagram illustrating a node information table in a state in which job X is assigned. FIG. 6 is a diagram illustrating a node information table in which job Y is assigned. FIG. 7 is a diagram illustrating a node information table in a state in which job Z is assigned. Here, descriptions will be made of a case where each node 2 is in the state illustrated by the node information table 121 in FIG. 3. Further, descriptions will be made of a case where the job information acquiring unit 11 receives a job in the order of job X, job Y, and job Z registered in the job information table 122 illustrated in FIG. 4. Moreover, in this case, the job execution controller 13 gives priority for the assignment to the upstream node when the influencing side raised temperature due to the execution of the job is large, and to the assignment to the downstream node when the influencing side raised temperature due to the job execution is small. For example, the job execution controller 13 determines that the influencing side raised temperature due to the job execution is large when the influencing side raised temperature is 10° C. or more.

The job execution controller 13 receives an input of the information of the job X from the job information acquiring unit 11. The influencing side raised temperature of the job X is 20° C., and the job execution controller 13 gives priority for the assignment to the upstream node. As illustrated in FIG. 3, the current temperature of the node #1 before the job X is put is 30° C. and the permissible temperature is 75° C. The influencing side raised temperature when the job X is executed is 20° C., and the influenced side raised temperature is 10° C. Therefore, the job execution controller 13 calculates the estimated temperature when the job X is executed on the node #1 by adding the influencing side raised temperature to the current temperature of the node #1 as 50° C. Since the estimated temperature obtained when the job X is executed on the node #1 is lower than the permissible temperature, the job execution controller 13 sets the node #1 as the assignment candidate node for the job X. In addition, the job execution controller 13 adds the influenced side raised temperature to the current temperature of the node #5, which is the downstream node in the temperature influence range of the node #1, which is the upstream node, and obtains the estimated temperature of the node #5 when the job X is executed on the node #1 as 43° C. Since the estimated temperature of the node #5 obtained when the job X is executed on the node #1 is lower than the permissible temperature, the job execution controller 13 determines to assign the job X to the node #1. Then, the job execution controller 13 registers the estimated temperature and the execution job of the node #1, and further registers the estimated temperature of the node #5. As a result, the node information table 121 becomes the state illustrated in FIG. 5.

Next, the job execution controller 13 receives an input of the information of the job Y from the job information acquiring unit 11. The influencing side raised temperature of the job Y is 5° C., and the job execution controller 13 gives priority for the assignment to the downstream node. The job execution controller 13 adds 5° C., which is the influencing side raised temperature when the job Y is executed to the current temperatures of the nodes #5 to #8 before the job Y illustrated in FIG. 5 is put, and obtains the estimated temperature when the job Y is executed on the nodes #5 to #8. Since the estimated temperature obtained when the job Y is executed on the nodes #5 to #8 is lower than the permissible temperature, the job execution controller 13 sets the nodes #5 to #8 as the assignment candidate nodes for the job Y. Here, since the nodes #5 to #8 are downstream nodes and do not belong to the influencing side node 2, the job execution controller 13 determines to assign the job Y to the nodes #5 to #8. Then, the job execution controller 13 registers the estimated temperatures and execution jobs of the nodes #5 to #8. As a result, the node information table 121 becomes the state illustrated in FIG. 6.

In addition, the job execution controller 13 receives an input of the information of the job Z from the job information acquiring unit 11. Here, this case will be described as a case immediately after completion of the execution of the job X on the node #1. At this time, it is assumed that the temperature of the node #1 is changed from the state of FIG. 6 and the current temperature reaches 50° C. In this case, when 30° C. which is the influencing side raised temperature of the job Z is added to the current temperature of the node #1, the temperature becomes 80° C. and exceeds the permissible temperature. Thus, the job execution controller 13 excludes the node #1 from the usable nodes.

Then, the job execution controller 13 adds 30° C., which is the influencing side raised temperature when the job Z is executed, to the current temperatures of the nodes #2 and #3 before the job Z illustrated in FIG. 6 is put, and obtains the estimated temperature when the job Z is executed on the nodes #2 and #3. Since the estimated temperature obtained when the job Z is executed on the nodes #2 and #3 is lower than the permissible temperature, the job execution controller 13 sets the nodes #2 and #3 as the assignment candidate nodes for the job Y. In addition, the job execution controller 13 adds the influenced side raised temperature to the estimated temperatures of the nodes #6 and #7, which are downstream nodes in the temperature influence range of the nodes #1 and #3 in the upstream node, and obtains the estimated temperatures of the nodes #6 and #7 when the job Z is executed on the nodes #2 and #3 as 49° C. Since the estimated temperatures of the nodes #6 and #7 when the job Z is executed on the nodes #2 and #3 are lower than the permissible temperature, the job execution controller 13 determines to assign the job Z to the nodes #2 and #3. Then, the job execution controller 13 registers the estimated temperatures and execution jobs of the nodes #2 and #3, and further registers the estimated temperatures of the nodes #6 and #7. As a result, the node information table 121 becomes the state illustrated in FIG. 7.

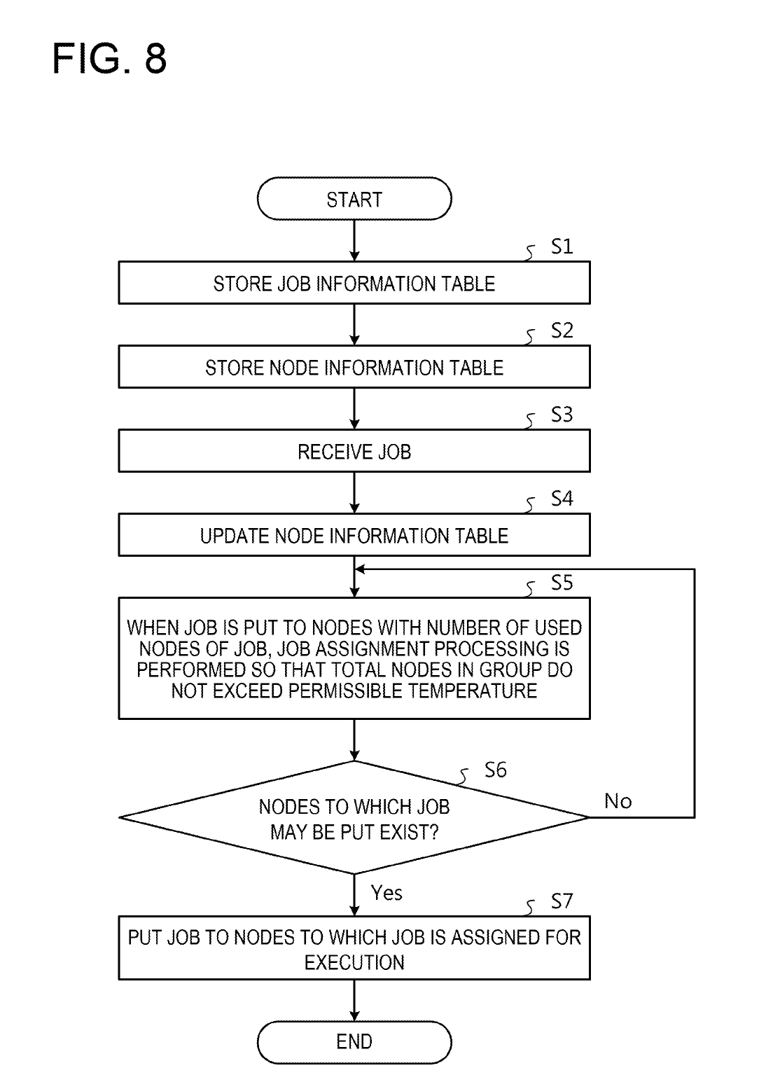

Next, a job assignment processing by the management node 1 according to the present embodiment will be described with reference to FIG. 8. FIG. 8 is a flowchart of the job assignment processing by the management node according to the first embodiment.

The job information acquiring unit 11 executes each predetermined job on the node 2 in advance, and acquires the influencing side raised temperature and the influenced side raised temperature when each job is executed. Then, the job information acquiring unit 11 creates the job information table 122 by registering the acquired temperature rise and the acquired influenced side raised temperature, and causes the storage unit 12 to store the job information table 122 (step S1).

In addition, the storage unit 12 stores a node information table 121 that registers the temperature influence range input from the operator and the permissible temperature of each node 2 (step S2).

Thereafter, the job information acquiring unit 11 receives the job (step S3). Then, the job information acquiring unit 11 acquires the job name of the received job. Next, the job information acquiring unit 11 acquires the number of used nodes corresponding to the acquired job name, the influencing side raised temperature, and the influenced side raised temperature from the job information table 122. Then, the job information acquiring unit 11 outputs the job name, the number of used nodes, the influencing side raised temperature, and the influenced side raised temperature to the job execution controller 13.

Also, the temperature information acquiring unit 14 acquires the measurement temperature from each node 2. Then, the temperature information acquiring unit 14 updates the node information table 121 by registering the acquired measurement temperature of each node 2 in the current temperature (step S4).

The job execution controller 13 receives an input of the job name, the number of used nodes, the influencing side raised temperature, and the influenced side raised temperature from the job information acquiring unit 11. In addition, the job execution controller 13 acquires the temperature influence range, the current temperature, and the permissible temperature of each node 2 from the node information table 121. Then, when the job is put to the node 2 having the number of used nodes of the job to be executed, the job execution controller 13 executes the job assignment so that all of the nodes 2 in the group do not exceed the permissible temperature (step S5).

Then, the job execution controller 13 determines whether there is a node 2 to which the job may be put (step S6). When it is determined that there is no node 2 to which the job may be put (“No” in step S6), the job execution controller 13 returns to step S5 and waits until the temperature of the node 2 is lowered and there is a node 2 to which the job may be put.

When it is determined that there is a node 2 to which the job may be put (“Yes” in step S6), the job execution controller 13 determines the node 2 to which the job is assigned. Then, the job execution controller 13 registers the execution job of the node 2 to which the job is assigned and the estimated temperature of each node 2 when the job is executed in the node information table 121. Thereafter, the job execution controller 13 executes the job by putting the job to the node 2 to which the job is assigned (step S7).

As described above, the management node according to the present embodiment obtains the estimated temperature of each node when the job is executed considering the temperature rise of the influenced side node when the influencing side node within the temperature influence range executes the job. Thus, since it is possible to obtain an appropriate estimated temperature considering the dependence of the temperature rise between the nodes, the temperature of each node may be accommodated within the permissible temperature. That is, the suppression of the operating frequency of each node may be avoided and the degradation of the processing performance of the computer may be suppressed.

Next, a second embodiment will be described. The management node according to the present embodiment is different from the first embodiment in that the node to which the job is assigned is determined in consideration of the resources used in the job. The management node according to the present embodiment is also illustrated in the block diagram of FIG. 2. In the following description, the operation of each part similar to that of the first embodiment will be omitted.

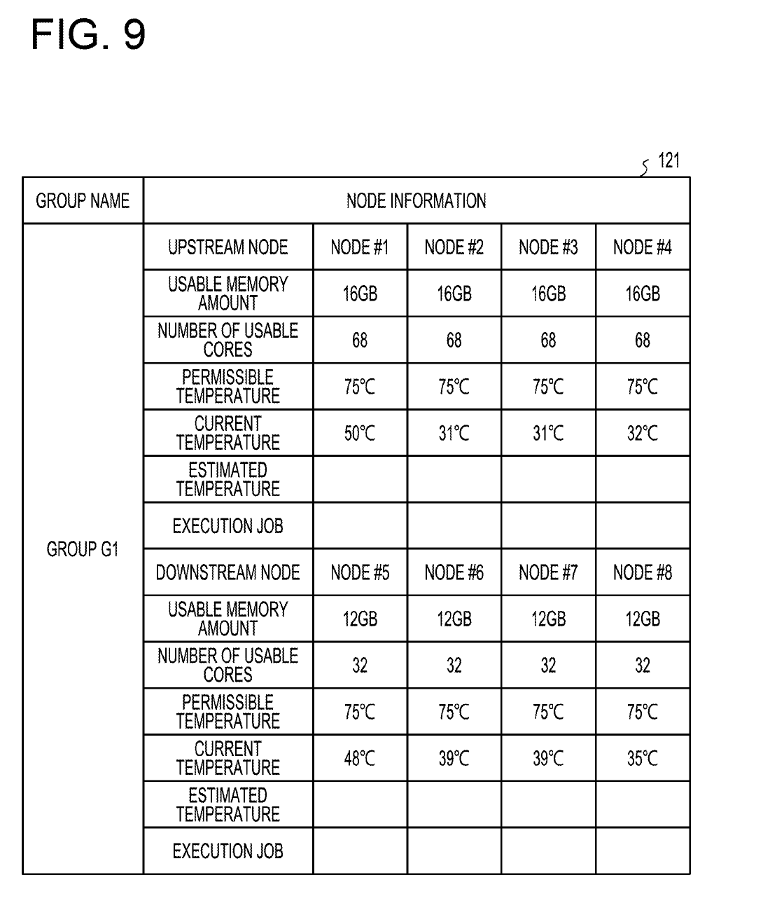

As illustrated in FIG. 9, the node information table 121 according to the present embodiment registers the usable memory amount of each node 2 and the number of usable cores. FIG. 9 is a diagram illustrating an example of a node information table according to a second embodiment.

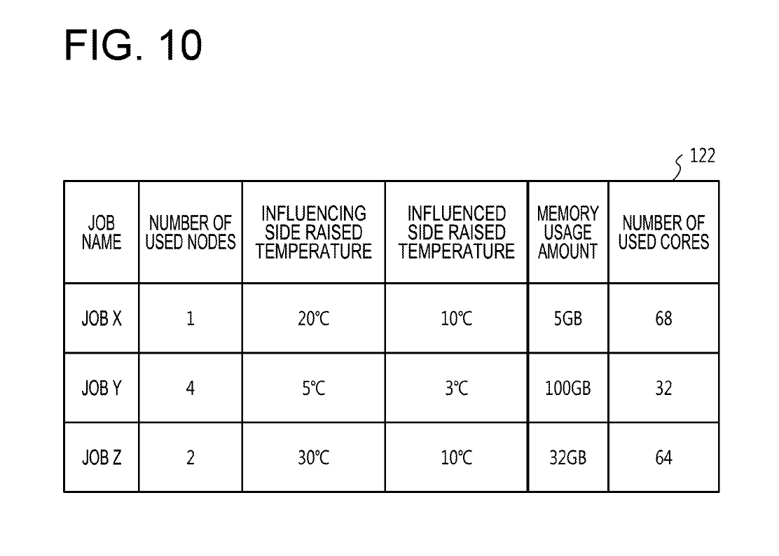

The job information acquiring unit 11 acquires the number of used nodes, the influencing side raised temperature, the influenced side raised temperature, the memory usage amount, and the number of used cores by previously executing the designated job on the node 2. Then, the job information acquiring unit 11 registers the acquired number of used nodes, influencing side raised temperature, influenced side raised temperature, memory usage amount, and number of used cores to create a job information table 122 as illustrated in FIG. 10. FIG. 10 is a diagram illustrating an example of a job information table according to the second embodiment.

The job execution controller 13 selects a combination of nodes 2 that may satisfy the memory usage amount and the number of used cores of the received job input from the job information acquiring unit 11 among the nodes 2 that are not performing the job in the nodes 2 registered in the node information table 121

Here, when it is difficult to select a combination of nodes 2 that may satisfy the memory usage amount and the number of used cores of the received job, the job execution controller 13 waits until the job execution of the node 2 that is performing the job is completed. Then, the job execution controller 13 repeatedly selects a combination of the nodes 2 that may satisfy the memory usage amount and the number of used cores of the received job among the nodes 2 that are not performing the job.

Next, the job execution controller 13 obtains the estimated temperature of each node 2 registered in the node information table 121 when the received job is executed on each of the selected combinations of nodes 2 by using the current temperature, the influencing side raised temperature, the influenced side raised temperature, and the temperature influence range. Then, the job execution controller 13 determines whether there is a node 2 exceeding the permissible temperature among the nodes 2 registered in the node information table 121 when the received job is executed on each of the selected combinations of nodes 2.

The job execution controller 13 excludes a combination in which the node 2 exceeding the permissible temperature exists from the assignment candidates of the received job. When there is no combination of nodes 2 that is the assignment candidate of the received job, the job execution controller 13 waits until the current temperature of each node 2 decreases, and then performs again the assignment of the received job. Then, the job execution controller 13 determines a combination of nodes 2 to which the received job is assigned from the remaining combinations of nodes 2. Thereafter, the job execution controller 13 put the received job to the assigned node 2 and executes the job.

As described above, the management node according to the present embodiment determines a combination of nodes to which the job is assigned among the combinations of nodes in which the respective nodes do not exceed the permissible temperature at the time of executing the job in the combinations of nodes satisfying the resources used in the job. Thus, it is possible to assign more appropriate jobs by selecting the nodes that may execute the job reliably, thereby enabling an efficient use of the computer.

Next, a third embodiment will be described. The management node according to the present embodiment is different from the first embodiment in that the node to which the job is assigned is determined in consideration of the priority of the job. The management node according to the present embodiment is also illustrated in the block diagram of FIG. 2. In the following description, the operation of each part similar to that of the first embodiment will be omitted.

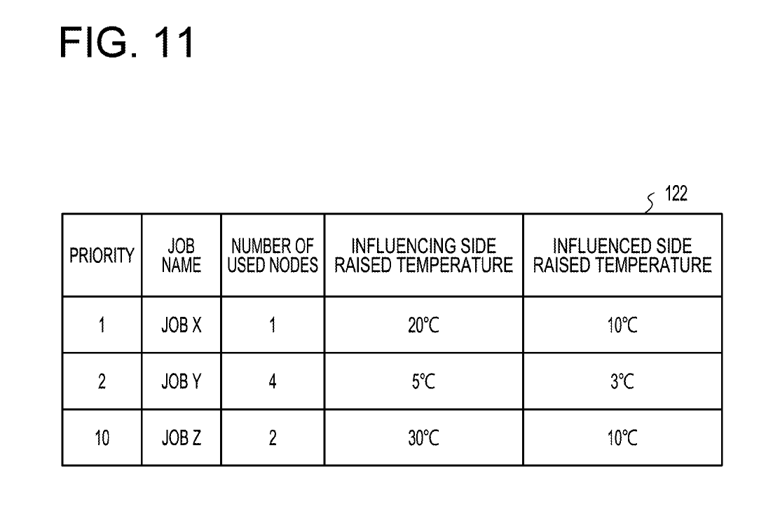

The job information acquiring unit 11 receives an input of the priority of each job from the operator. Then, the job information acquiring unit 11 registers the priority of each of the jobs registered in the job information table 122. Thus, the job information acquiring unit 11 creates the job information table 122 illustrated in FIG. 11. FIG. 11 is a diagram illustrating an example of a job information table according to a third embodiment.

The job execution controller 13 receives an input of the priority from the job information acquiring unit 11 in addition to the job name of the received job, the number of used nodes, the influencing side raised temperature, and the influenced side raised temperature. Then, when the priority of the received job is high, the job execution controller 13 assigns the nodes 2 in the descending order of the temperature among the nodes 2 to which the received job may be assigned. Here, the job execution controller 13 has a threshold value for determining the priority level. When the priority is higher than the threshold value, the job execution controller 13 determines that the priority of the received job is high. Further, the division of the jobs using the priority may not be two (high and low), and the job execution controller 13 may assign the node 2 having a temperature according to each part by dividing the job into three or more parts by using the priority.

In addition, when multiple jobs are received at the same time or multiple jobs are in a waiting state of assignment, the job execution controller 13 first performs assignment to the jobs having higher priority. For example, the job execution controller 13 receives the execution instruction of the job Z from the job information acquiring unit 11, and thereafter receives the execution instruction of the job Y from the job information acquiring unit 11 before assigning the job Z. In this case, the job execution controller 13 causes the jobs Y and Z to be in a waiting state of assignment. Since the job Y has a higher priority than the job Z, the job execution controller 13 waits until the assignment of the job Y becomes possible, and thereafter, performs assignment of the job Z after assigning the job Y to the node 2.

Also, even in the case of assignment in consideration of the used resources of the job as in the second embodiment, the job execution controller 13 may perform a job assignment according to the priority. For example, when multiple jobs are received at the same time or multiple jobs are in a waiting state of assignment, the job execution controller 13 first performs assignment to the jobs having higher priority.

As described above, the management node according to the present embodiment performs a job assignment to the node according to the priority of the job. Thus, it is possible to execute the job at the priority designated by the operator, thereby enabling more efficient use of the computer.

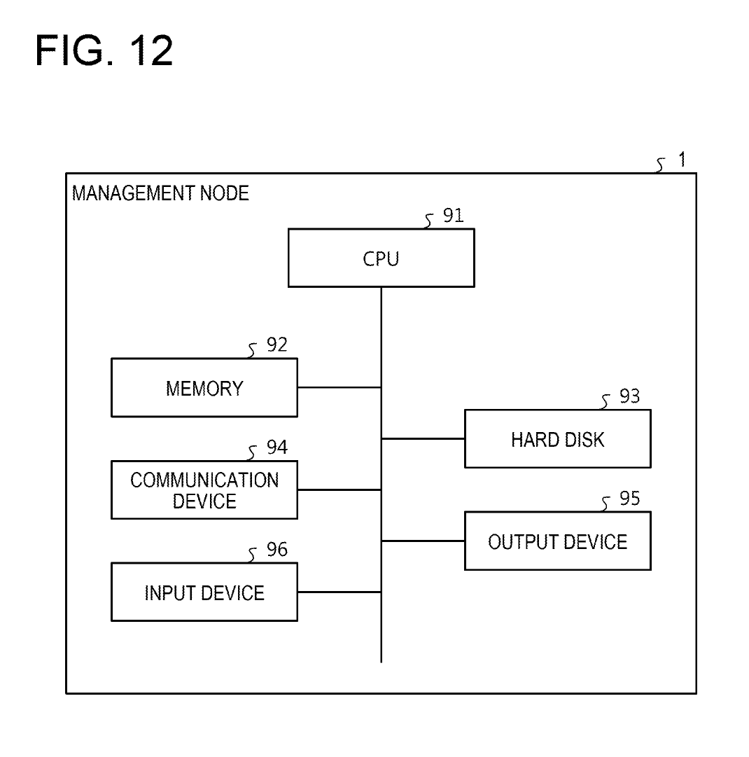

(Hardware Configuration) FIG. 12 is a hardware configuration diagram of the management node. As illustrated in FIG. 12, the management node 1 includes a CPU 91, a memory 92, a hard disk 93, a communication device 94, an output device 95, and an input device 96. The CPU 91 is connected to the memory 92, the hard disk 93, the communication device 94, the output device 95, and the input device 96 by a bus.

The memory 92 is a main storage device. The hard disk 93 is an auxiliary storage device. For example, the hard disk 93 implements the function of the storage unit 12 by storing the node information table 121 and the job information table 122. In addition, the hard disk 93 stores various programs including a program that implements the functions of the job information acquiring unit 11, the job execution controller 13, and the temperature information acquiring unit 14 illustrated in FIG. 2.

The communication device 94 is a device having a communication interface with the node 2. The CPU 91 communicates with the node 2 via the communication device 94.

The output device 95 is, for example, a monitor. Further, the input device 96 is, for example, a keyboard or a mouse. The operator uses the output device 95 and the input device 96 to input instructions and information to the CPU 91.

The CPU 91 reads out various programs including a program that implements the functions of the job information acquiring unit 11, the job execution controller 13, and the temperature information acquiring unit 14 illustrated in FIG. 2 from the hard disk 93 so as to develop and execute the read various programs on the memory 92. Thus, the CPU 91 and the memory 92 implement the functions of the job information acquiring unit 11, the job execution controller 13, and the temperature information acquiring unit 14 illustrated in FIG. 2.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus, comprising:
a memory; and
a processor coupled to the memory and the processor configured to:
acquire a temperature of each of a plurality of arithmetic processing devices;
acquire a first raised temperature and a second raised temperature for a first predetermined processing, the first raised temperature being a temperature expected to be raised in a first arithmetic processing device if the first arithmetic processing device executes the first predetermined processing, the second raised temperature being a temperature expected to be raised in a second arithmetic processing device if the first arithmetic processing device executes the first predetermined processing, the second arithmetic processing device being different from the first arithmetic processing device; and
determine an arithmetic processing device to be assigned to execute the first predetermined processing, based on the temperature of each of the plurality of arithmetic processing devices, the first raised temperature, and the second raised temperature.

2. The information processing apparatus according to claim 1, wherein
the processor is configured to:
store in advance, in the memory, information on an influenced arithmetic processing device in which a temperature rises when a temperature of a predetermined arithmetic processing device rises; and
acquire the first raised temperature of the predetermined arithmetic processing device and the second raised temperature of the influenced arithmetic processing device, which are expected to be raised if the predetermined arithmetic processing device executes the first predetermined processing.

3. The information processing apparatus according to claim 1, wherein
the processor is configured to determine the arithmetic processing device to be assigned to execute the first predetermined processing such that a temperature of each of the arithmetic processing devices falls within a permissible temperature of each of the arithmetic processing devices even when the determined arithmetic processing device executes the first predetermined processing.

4. The information processing apparatus according to claim 1, wherein
the processor is configured to:
store, in the memory, information on resources included in each of the arithmetic processing devices; and
determine the arithmetic processing device to be assigned to execute the first predetermined processing, from among arithmetic processing devices which includes an amount of resources to be used in the first predetermined processing.

5. The information processing apparatus according to claim 1, wherein
the processor is configured to determine, in accordance with a predetermined priority of each of a plurality of predetermined processings to be executed by any of the plurality of arithmetic processing devices, respective arithmetic processing devices to be assigned to execute the plurality of predetermined processings.

6. An information processing system, comprising:
a plurality of arithmetic processing devices; and
an information processing apparatus including:
a memory; and
a processor coupled to the memory and the processor configured to:
acquire a temperature of each of the plurality of arithmetic processing devices;
acquire a first raised temperature and a second raised temperature for a first predetermined processing, the first raised temperature being a temperature expected to be raised in a first arithmetic processing device if the first arithmetic processing device executes the first predetermined processing, the second raised temperature being a temperature expected to be raised in a second arithmetic processing device if the first arithmetic processing device executes the first predetermined processing, the second arithmetic processing device being different from the first arithmetic processing device; and
determine an arithmetic processing device to be assigned to execute the first predetermined processing, based on the temperature of each of the plurality of arithmetic processing devices, the first raised temperature, and the second raised temperature.

7. A non-transitory computer-readable recording medium having stored therein a program that causes a computer to execute a process, the process comprising:
acquiring a temperature of each of a plurality of arithmetic processing devices;
acquiring a first raised temperature and a second raised temperature for a first predetermined processing, the first raised temperature being a temperature expected to be raised in a first arithmetic processing device if the first arithmetic processing device executes the first predetermined processing, the second raised temperature being a temperature expected to be raised in a second arithmetic processing device if the first arithmetic processing device executes the first predetermined processing, the second arithmetic processing device being different from the first arithmetic processing device; and
determining an arithmetic processing device to be assigned to execute the first predetermined processing, based on the temperature of each of the plurality of arithmetic processing devices, the first raised temperature, and the second raised temperature.
